(19) United States
(12) Patent Application Publication
(10) Pub. No.: US 2020/0117784 A1
(43) Pub. Date: Apr. 16, 2020

(54) INFORMATION PROCESSING DEVICE, INFORMATION PROCESSING METHOD, AND INFORMATION PROCESSING PROGRAM

(71) Applicant: FUJITSU CONNECTED TECHNOLOGIES LIMITED, Yamato-shi (JP)

(72) Inventors: Junya Yamaguchi, Yokohama (JP); Hiroshi Fujino, Fuchu (JP)

(73) Assignee: FUJITSU CONNECTED TECHNOLOGIES LIMITED, Yamato-shi (JP)

(21) Appl. No.: 16/707,092

(22) Filed: Dec. 9, 2019

Related U.S. Application Data
(63) Continuation of application No. PCT/JP2018/021350, filed on Jun. 4, 2018.

(30) Foreign Application Priority Data
Jun. 13, 2017 (JP) 2017-116185

(51) Int. Cl. G06F 21/32

(52) U.S. Cl. CPC G06F 21/32

(57) ABSTRACT

An information processing device includes a first specifying unit for specifying identification information on a user who operates the information processing device and identification information on each of one or more other users who use the information processing device while sharing the information processing device with the user, and a second specifying unit for referring to a first storage unit which has stored a range of operable information corresponding to a combination of identification information on users, to specify a range of operable information to a combination of the identification information specified by the first specifying unit.

### CROSS-REFERENCE TO RELATED APPLICATION

International Application PCT/JP2018/021350 filed on Jun. 4, 2018 is based upon and claims the benefit of priority of the prior Japanese Patent Application No. 2017-116185, filed on Jun. 13, 2017, the entire contents of which are incorporated herein by reference.

This application is a continuation application of the International Application PCT/JP2018/021350 and designated the U.S., the entire contents of which are incorporated herein by reference.

### FIELD

The embodiments relate to an information processing device, an information processing method, and an information processing program.

### BACKGROUND

Smartphones and tablet terminals are frequently equipped with user authentication functions for the purpose of preventing fraudulent manipulation and preventing leakage of personal information. As a user authentication function, for example, authentication using biometric information as authentication information, such as iris authentication, face authentication, and vein authentication, is known.

In tablet terminals, an authority level is allocated to a user authenticated by a user authentication function, and operable information is limited in accordance with the authority level allocated to the user. In recent years, one tablet terminal is simultaneously used by a plurality of persons.

Note that techniques relating to the present application are disclosed in Japanese Laid-open Patent Application Publication No. 2015-207275, Japanese Laid-open Patent Application Publication No. H09-147233 and Japanese Laid-open Patent Application Publication No. 2001-290925.

Conventionally, however, an authority level allocated to a user authenticated by user authentication (that is, logged-in user) is effective. Thus, even when a terminal is simultaneously used by a plurality of persons, the terminal may be used only at an authority level of one user among the plurality of persons, and it is not possible to operate necessary information in some cases.

For example, in the case where a parent and a child use a terminal together, when the terminal is used in the state in which the child is logged in, a low authority level is effective, and it is not possible to refer to necessary information in some cases. On the other hand, in the case where the terminal is used in the state in which the parent is logged in, a high authority level is effective, and even information that is not preferred to the child may be referenced.

### SUMMARY

According to one aspect of the embodiments, an information processing device includes a first specifying unit for specifying identification information on a user who operates the information processing device and identification information on each of one or more other users who use the information processing device while sharing the information processing device with the user, and a second specifying unit for referring to a first storage unit which has stored a range of operable information corresponding to a combination of identification information on users, to specify a range of operable information to a combination of the identification information specified by the first specifying unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration of a terminal device according to a first embodiment;

FIG. 2 is a diagram illustrating an example of authentication information stored in an authentication information storage unit;

FIG. 3 is a diagram illustrating an example of an authority table stored in an authority table storage unit;

FIGS. 4A and 4B are diagrams for describing an example of setting of authority levels according to the first embodiment;

FIG. 5 is a diagram illustrating an example of a hardware configuration of the terminal device according to the first embodiment;

FIG. 6 is a diagram illustrating an example of a functional configuration of an authentication processing unit according to the first embodiment;

FIG. 7 is a flowchart illustrating an example of processing for performing use authentication and setting an authority level according to the first embodiment;

FIG. 8 is a diagram illustrating an example of an overall configuration of a system including a terminal device according to a second embodiment;

FIG. 9 is a diagram for describing an example of setting of authority levels according to the second embodiment;

FIG. 10 is a diagram illustrating an example of a functional configuration of an authentication processing unit according to the second embodiment;

FIG. 11 is a diagram illustrating an example of the flow of overall processing for performing use authentication and setting an authority level according to the second embodiment;

FIG. 12 is a flowchart illustrating an example of processing for performing use authentication and specifying user authority in a master device according to the second embodiment;

FIG. 13 is a flowchart illustrating an example of processing for performing use authentication and setting an authority level in a slave device according to the second embodiment; and

FIG. 14 is a diagram illustrating an example of an overall configuration of a system including a terminal device according to a third embodiment.

### DESCRIPTION OF EMBODIMENTS

The embodiments are described below with reference to the accompanying drawings.

### First Embodiment

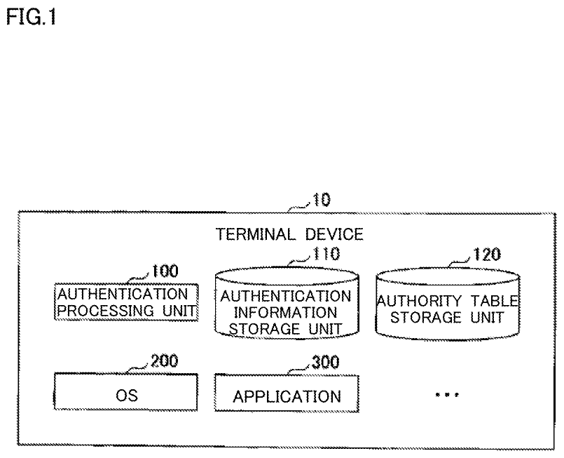

First, the overall configuration of a terminal device 10 according to the present embodiment is described with reference to FIG. 1. FIG. 1 is a diagram illustrating an example of the overall configuration of the terminal device 10 according to the present embodiment. The terminal device 10 illustrated in FIG. 1 is, for example, an information processing device such as a tablet terminal, a notebook personal computer (PC), a desktop computer, a smartphone, and a game device. The following description assumes that the terminal device 10 is a tablet terminal as an example.

As illustrated in FIG. 1, the terminal device 10 according to the present embodiment includes an authentication processing unit 100, an authentication information storage unit 110, and an authority table storage unit 120. The authentication processing unit 100 is implemented by processing for causing a CPU 507 described later to execute one or more programs installed on the terminal device 10. For example, the authentication information storage unit 110 and the authority table storage unit 120 may be implemented by using an auxiliary storage device 508 described later.

The terminal device 10 according to the present embodiment has an operating system (OS) 200 as basic software and an application 300 as software for providing various kinds of functions on the OS200. Examples of the application 300 includes a Web browser, a movie viewing application, a social networking service (SNS) application, and an address application.

The authentication processing unit 100 uses taken images created by photographing one or more users to perform use authentication of the one or more users by iris authentication. The authentication processing unit 100 sets an authority level corresponding to a combination of authority (user authority) allocated to the one or more users to the OS200 or the application 300.

When the authority level is set to the OS200 or the application 300, the user of the terminal device 10 may perform operations of information (for example, reference, deletion, and update of information, and use of various kinds of functions) corresponding to the authority level. As the authority level becomes higher, the limitation of the range of information that may be operated becomes lower. In contrast, as the authority level becomes lower, the limitation of the range of information that may be operated becomes higher.

Use authentication of a user by the authentication processing unit 100 is not limited to iris authentication. For example, the authentication processing unit 100 may perform various kinds of biometric authentication such as face authentication, vein authentication, and fingerprint authentication. For example, the authentication processing unit 100 may perform authentication by input of passcode, without being limited to biometric authentication. The following description assumes that the authentication of a user by the authentication processing unit 100 is iris authentication.

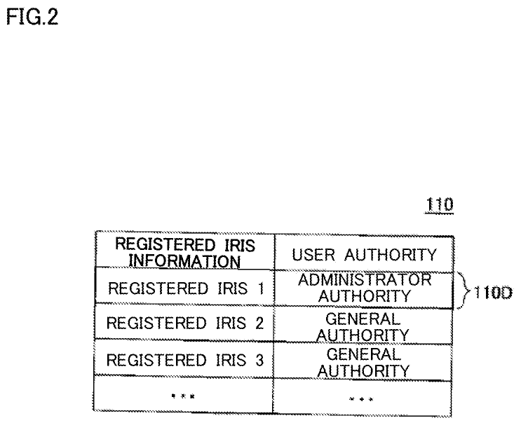

The authentication information storage unit 110 stores authentication information 110D therein. Details of the authentication information 110D stored in the authentication information storage unit 110 are described with reference to FIG. 2. FIG. 2 is a diagram illustrating an example of the authentication information 110D stored in the authentication information storage unit 110.

As illustrated in FIG. 2, in the authentication information 110D stored in the authentication information storage unit 110, registered iris information indicating iris information registered by a user using the terminal device 10 in advance and user authority of the user are associated.

For example, registered iris information “registered iris 1” is associated with user authority “administrator authority”. This indicates that a user authenticated by the registered iris information “registered iris 1” is allocated with the user authority “administrator authority”.

For example, registered iris information “registered iris 2” is associated with user authority “general authority”. This indicates that a user authenticated by the registered iris information “registered iris 2” is allocated with the user authority “general authority”.

In this manner, in the authentication information storage unit 110, the authentication information 110D in which registered iris information on a user and authority allocated to the user are associated is stored. The user authority is not limited to “administrator authority” and “general authority”. For example, an intermediate authority (for example, “sub administrator authority”) between “administrator authority” and “general authority” may be present, and authority (for example, “guest authority”) lower than “general authority” may be present.

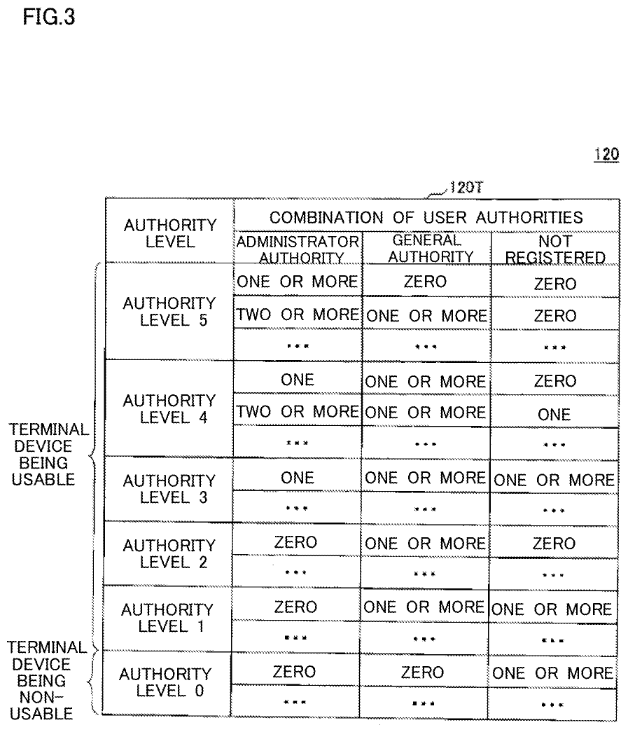

The authority table storage unit 120 stores an authority table 120T therein. Details of the authority table 120T stored in the authority table storage unit 120 are described with reference to FIG. 3. FIG. 3 is a diagram illustrating an example of the authority table 120T stored in the authority table storage unit 120.

As illustrated in FIG. 3, in the authority table 120T stored in the authority table storage unit 120, an authority level for limiting the range of information that may be operated by a user of the terminal device 10 and a combination of user authorities set when one or more users perform use authentication are associated. For example, the user authorities include “administrator authority”, “general authority”, and “not registered”. The user authority “not registered” indicates that authentication information 110D including iris information on a user who has performed use authentication is not stored in the authentication information storage unit 110.

For example, when one or more users allocated with the administrator authority perform use authentication, a combination of the user authorities is “one or more administrator authorities, no general authority, and no not registered”. Thus, in this case, the one or more users may use the terminal device 10 at “authority level 5” as the highest authority level.

For example, when one user allocated with the administrator authority and one or more users allocated with the general authority perform use authentication, a combination of the user authorities is “one administrator authority, one or more general authorities, and no not registered”. Thus, in this case, these users may use the terminal device 10 at “authority level 4” as an authority level lower than the authority level 5 by 1.

For example, when one user allocated with the administrator authority, one or more users allocated with the general authority, and one or more users whose iris information is not registered perform use authentication, a combination of the user authorities is “one administrator authority, one or more general authorities, and one or more not registered”. Thus, in this case, these users may use the terminal device 10 at “authority level 3” as an authority level lower than the authority level 4 by 1.

Similarly, for example, when one or more users allocated with the general authority perform use authentication, a combination of the user authorities is “no administrator authority, one or more general authorities, and no not registered”. Thus, in this case, these users may use the terminal device 10 at “authority level 2” as an authority level lower than the authority level 3 by 1.

Similarly, for example, when one or more users allocated with the general authority and one or more users whose iris information is not registered perform use authentication, a combination of the user authorities is “no administrator authority, one or more general authorities, and one or more not registered”. Thus, in this case, these users may use the terminal device 10 at “authority level 1” as an authority level lower than the authority level 2 by 1.

On the other hand, for example, when one or more users whose iris information is not registered perform use authentication, a combination of the user authorities is “no administrator authority, no general authority, and one or more not registered”. Thus, in this case, “authority level 0” as an authority level at which it is not possible to use the terminal device 10 is set, and it is not possible to use the terminal device 10 by these users.

In this manner, in the authority table storage unit 120, the authority table 120T associated with the authority level for limiting the range of information that may be operated by one or more users using the terminal device 10 and the combination of the user authorities allocated to each of the one or more users is stored.

The authority level and the combination of the user authorities in the authority table 120T illustrated in FIG. 3 are examples, and are not limited thereto. For example, the combination of the user authorities with respect to each authority level may be freely set by a user having administrator authority. For example, the authority levels are not limited to “authority level 0” to “authority level 5”, and any number of authority levels may be set.

In the authority table 120T illustrated in FIG. 3, the authority level and the combination of the user authorities are associated, but the embodiment is not limited thereto. For example, in the authority table 120T, the authority level and a combination of registered iris information may be associated, and the authority level and a user ID for identifying a user may be associated.

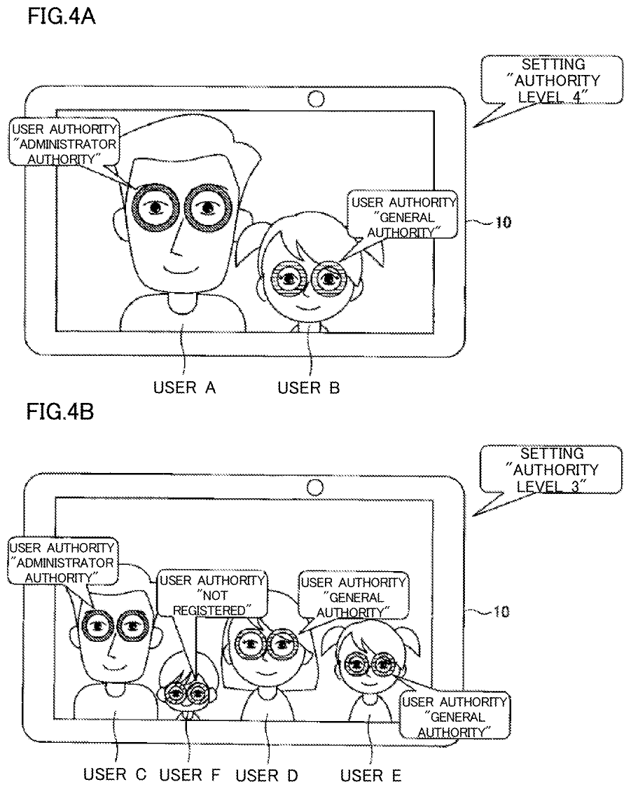

The outline in the case where the terminal device 10 according to the present embodiment performs use authentication of one or more users to set authority levels of the users is described with reference to FIGS. 4A and 4B. FIGS. 4A and 4B are diagrams for describing an example of setting of authority levels according to the present embodiment.

The example illustrated in FIG. 4A indicates the case where a user A allocated with user authority “administrator authority” and a user B allocated with user authority “general authority” perform use authentication by iris authentication. In this case, the authentication processing unit 100 refers to the authority table 120T to set an authority level “authority level 4” corresponding to a combination of the user authority “administrator authority” and the user authority “general authority” to the OS200 or the application 300. In this manner, the user A and the user B may perform operations of information corresponding to the authority level 4.

The example illustrated in FIG. 4B indicates the case where a user C allocated with user authority “administrator authority”, a user D and a user E allocated with user authority “general authority”, and a user F having user authority “not registered” perform use authentication by iris authentication. In this case, the authentication processing unit 100 refers to the authority table 120T to set an authority level “authority level 3” corresponding to a combination of the user authority “administration authority”, the two user authorities “general authority”, and the user authority “not registered” to the OS200 or the application 300. In this manner, the user C, the user D, the user E, and the user F may perform operations of information corresponding to the authority level 3.

As described above, the terminal device 10 according to the present embodiment specifies an authority level for limiting the range of information that may be operated in accordance with a combination of user authority of one or more user whose use authentication has been performed. In other words, the terminal device 10 according to the present embodiment may change the authority level of a user who operates the terminal device 10 in accordance with user authority of another user whose use authentication has been performed together with the user.

In this manner, for example, when a parent and a child together use the terminal device 10, the parent and the child may use the terminal device 10 at an authority level lower than an authority level set when the parent uses the terminal device 10 alone and higher than an authority level set when the child uses the terminal device 10 alone. In other words, for example, when a child uses the terminal device 10 together with a parent, the authority level of the child may be temporarily changed to an authority level (for example, authority level 4) higher than an authority level (for example, authority level 2) set when the child uses the terminal device 10 alone.

Thus, for example, in the case where an application 300 needs to be prevented from being used by a child alone and the child uses the application 300 together with a parent, the authority level of the child may be changed when the application 300 needs to be used while a part of functions are restricted. This is because, for example, when a child uses the terminal device 10 together with a parent, a movie viewing application 300 may need to be used while inappropriate contents from a child educational standpoint (for example, contents including violence scenes) are eliminated.

For example, when two users having user authority “sub administrator authority” use the terminal device 10, the terminal device 10 may be used at the same authority level as that of a user having user authority “administrator authority”. In this manner, the terminal device 10 according to the present embodiment may flexibly set the authority level in accordance with a combination of user authority allocated to users.

In addition, the terminal device 10 according to the present embodiment uses iris authentication as use authentication, and hence may authenticate a plurality of users at the same time. Thus, for example, use authentication may be performed in a short period of time as compared with the case where a plurality of users sequentially input passcodes. Other than iris authentication, for example, face authentication may be used to authenticate a plurality of users at the same time. When face authentication is used, information indicating a characteristic pattern of a face is used instead of iris information.

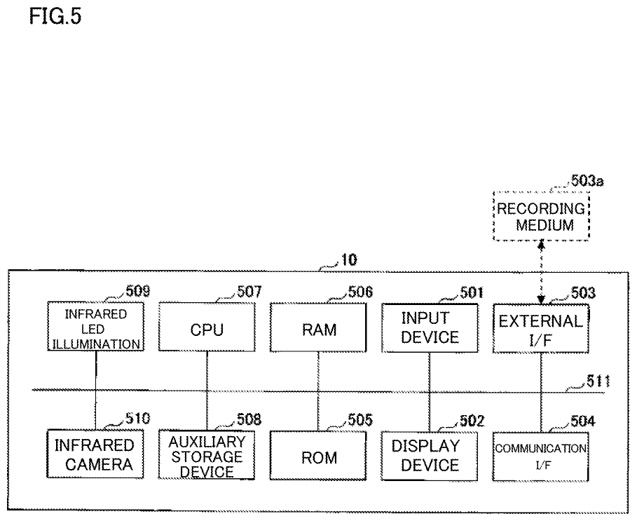

Next, a hardware configuration of the terminal device 10 according to the present embodiment is described with reference to FIG. 5. FIG. 5 is a diagram illustrating an example of the hardware configuration of the terminal device 10 according to the present embodiment.

As illustrated in FIG. 5, the terminal device 10 according to the present embodiment includes an input device 501, a display device 502, an external I/F 503, a communication I/F 504, and a read only memory (ROM) 505. The terminal device 10 according to the present embodiment includes a random access memory (RAM) 506, a central processing unit (CPU) 507, an auxiliary storage device 508, an infrared light emitting diode (LED) illumination 509, and an infrared camera 510. These pieces of hardware are mutually connected by a bus 511.

For example, the input device 501 is a touch panel, and is used to input various kinds of operations to the terminal device 10. The input device 501 may be a keyboard and a mouse.

For example, the display device 502 is a display, and displays various kinds of processing results by the terminal device 10.

The external I/F 503 is an interface for external devices. Examples of the external devices include a recording medium 503a. The terminal device 10 may read and write data from and to the recording medium 503a through the external I/F 503.

For example, the recording medium 503a is an SD memory card or a USB memory. For example, the recording medium 503a may be a compact disk (CD) or a digital versatile disk (DVD).

The communication I/F 504 is an interface for the terminal device 10 to communicate with other devices. The terminal device 10 may communicate with other devices through the communication I/F 504.

The ROM 505 is a nonvolatile semiconductor memory that may hold data even when powered off. The RAM 506 is a volatile semiconductor memory that may temporarily hold programs and data. For example, the CPU 507 is an arithmetic device for executing various kinds of processing by reading programs and data onto the RAM 506 from the auxiliary storage device 508 and the ROM 505.

The auxiliary storage device 508 is nonvolatile memory that stores programs and data therein. Examples of the auxiliary storage device 508 include a flash memory. For example, a hard disk drive (HDD) may be used for the auxiliary storage device 508.

Examples of the programs and data stored in the auxiliary storage device 508 include one or more programs that implement the authentication processing unit 100, an OS200, and an application 300.

The infrared LED illumination 509 is an illumination device for emitting infrared rays. The infrared camera 510 is a camera device having sensitivity to infrared rays.

The terminal device 10 according to the present embodiment implements various kinds of processing described later owing to the hardware configuration illustrated in FIG. 5.

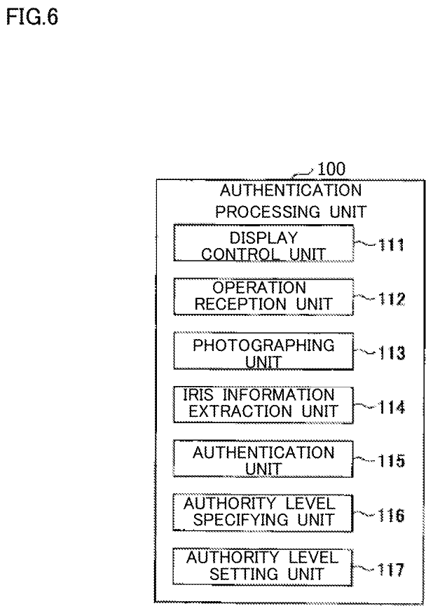

Next, a functional configuration of the authentication processing unit 100 according to the present embodiment is described with reference to FIG. 6. FIG. 6 is a diagram illustrating an example of the functional configuration of the authentication processing unit 100 according to the present embodiment.

As illustrated in FIG. 6, the authentication processing unit 100 according to the present embodiment includes a display control unit 111, an operation reception unit 112, a photographing unit 113, an iris information extraction unit 114, an authentication unit 115, an authority level specifying unit 116, and an authority level setting unit 117.

The display control unit 111 displays various kinds of screens. For example, the display control unit 111 displays a photographing start screen for photographing a user subjected to use authentication.

The operation reception unit 112 receives various kinds of operations made by the user. For example, the operation reception unit 112 receives a photographing start operation made by the user.

When the operation reception unit 112 receives the photographing start operation, the photographing unit 113 photographs an area within a photographing range to generate taken image data. Specifically, the photographing unit 113 applies infrared rays by the infrared LED illumination 509 to photograph an area within the photographing range of the infrared camera 510, thereby generating taken image data.

The iris information extraction unit 114 extracts iris information indicating an iris pattern of the photographed user from the taken image data generated by the photographing unit 113.

The authentication unit 115 specifies user authority of each photographed user on the basis of the iris information extracted by the iris information extraction unit 114 and authentication information 110D stored in the authentication information storage unit 110. Specifically, when authentication information 110D including registered iris information that matches the iris information on the photographed user is stored in the authentication information storage unit 110, the authentication unit 115 specifies user authority associated with the registered iris information. On the other hand, when authentication information 110D including registered iris information that matches the iris information on the photographed user is not stored in the authentication information storage unit 110, the authentication unit 115 specifies user authority as “not registered”.

The authority level specifying unit 116 refers to an authority table 120T stored in the authority table storage unit 120 to specify an authority level on the basis of a combination of user authorities specified by the authentication unit 115.

The authority level setting unit 117 sets the authority level specified by the authority level specifying unit 116 to the OS200 or the application 300, for example. Setting the authority level to the OS200 and the application 300 enables a user of the terminal device 10 to perform operation of information corresponding to the authority level. In other words, the user of the terminal device 10 may perform operations of various kinds of information on the OS200 and the application 300 with operation authority at the authority level set by the authority level setting unit 117.

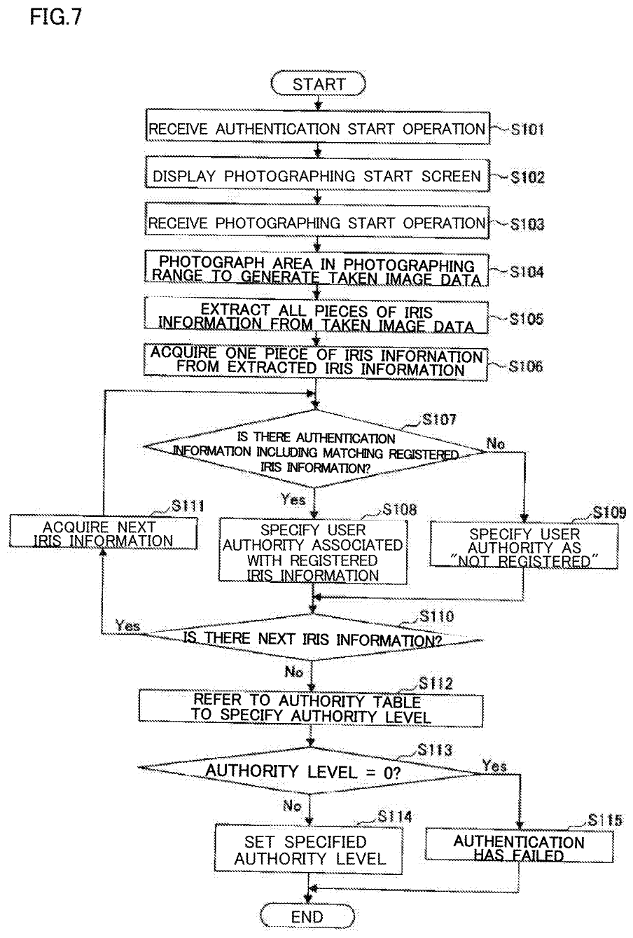

Next, the processing for performing the use authentication and setting the authority level in the terminal device 10 according to the present embodiment is described with reference to FIG. 7. FIG. 7 is a flowchart illustrating an example of the processing for performing the use authentication and setting the authority level according to the present embodiment.

First, the operation reception unit 112 receives an authentication start operation by a user (Step S101). For example, the user may perform the authentication start operation by performing an operation for resuming the terminal device 10 from a sleep state.

Next, the display control unit 111 displays a photographing start screen for photographing a user subjected to use authentication (Step S102). For example, the display control unit 111 may display the photographing start screen after passcode authentication by the user has succeeded. In other words, use authentication by iris authentication may be performed as a second stage of authentication of the terminal device 10.

Next, the operation reception unit 112 receives a photographing start operation (Step S103). For example, the user may perform the photographing start operation by pressing a photographing start button displayed on the photographing start screen. In this case, when a plurality of users use the terminal device 10 by sharing the terminal device 10 (for example, when a parent and a child together use the terminal device 10), the user performs a photographing start operation in the state in which the irises of the plurality of users are included in a photographing range.

Specifically, the user performs a photographing start operation in the state in which the user who is actually operating the terminal device 10 and one or more other users who use the terminal device 10 together with the user (one or more other user who share the same screen with the user) are included in the photographing range.

Next, when the operation reception unit 112 receives the photographing start operation, the photographing unit 113 photographs an area in the photographing range to generate taken image data (Step S104). In this manner, the irises of one or more users using the terminal device 10 are photographed to generate taken image data.

Next, the iris information extraction unit 114 extracts iris information on the photographed user from the taken image data generated by the photographing unit 113 (Step S105). In this case, when the irises of a plurality of users are photographed at Step S104, a plurality of pieces of iris information indicating iris patterns of the plurality of users are extracted.

Next, the authentication unit 115 acquires one piece of iris information from the iris information extracted by the iris information extraction unit 114 (Step S106).

Next, the authentication unit 115 determines whether authentication information 110D including registered iris information that matches the acquired iris information is stored in the authentication information storage unit 110 (Step S107). In other words, the authentication unit 115 determines whether the acquired iris information is registered in the terminal device 10.

At Step S107, when it is determined that authentication information 110D including registered iris information that matches the acquired iris information is stored in the authentication information storage unit 110, the authentication unit 115 specifies user authority associated with the registered iris information (Step S108).

For example, when registered iris information that matches the acquired iris information is “registered iris 1”, the authentication unit 115 specifies user authority “administrator authority” associated with the registered iris information “registered iris 1”.

For example, when registered iris information that matches the acquired iris information is “registered iris 2”, the authentication unit 115 specifies user authority “general authority” associated with the registered iris information “registered iris 2”.

On the other hand, at Step S107, when it is determined that authentication information 110D including registered iris information that matches the acquired iris information is not stored in the authentication information storage unit 110, the authentication unit 115 specifies the user authority as “not registered” (Step S109).

Subsequently to Step S108 or Step S109, the authentication unit 115 determines whether the next iris information (that is, unacquired iris information) is present in the iris information extracted by the iris information extraction unit 114 (Step S110).

At Step S110, when it is determined that the next iris information is present, the authentication unit 115 acquires the next iris information (Step S111). The authentication unit 115 returns to Step S107. In this manner, the processing at Step S107 and the processing at Step S108 or Step S109 are performed on all pieces of iris information extracted by the iris information extraction unit 114.

On the other hand, at Step S110, when it is determined that the next iris information is not present, the authority level specifying unit 116 refers to the authority table 120T to specify an authority level from a combination of user authorities specified by the authentication unit 115 (Step S112).

Next, the authority level specifying unit 116 determines whether the authority level specified at Step S112 is “authority level 0” (that is, authority level at which it is not possible to use the terminal device 10) (Step S113).

At Step S113, when it is determined that the specified authority level is not “authority level 0”, the authority level setting unit 117 sets the specified authority level to, for example, the OS200 or the application 300 (Step S114).

In this manner, the user may use various kinds of functions provided by the OS200 (for example, file system) and various kinds of functions provided by the application 300 (for example, Web browsing function, movie viewing function, and SNS function) at the authority level set by the authority level setting unit 117. In other words, the user of the terminal device 10 may perform operations of various kinds of information with operation authority at the authority level set by the authority level setting unit 117.

On the other hand, at Step S113, when it is determined that the specified authority level is “authority level 0”, the authentication unit 115 determines that the authentication has failed (Step S115). In this case, for example, the display control unit 111 may display a screen indicating that it is not possible to use the terminal device 10 because the authentication has failed.

As described above, in the terminal device 10 according to the present embodiment, when a user uses the terminal device 10 together with another user, the authority level that limits the range of information that may be operated by the user is set in accordance with a combination of user authorities allocated to the plurality of users. In this manner, the authority level may be flexibly set in accordance with a combination of user authorities allocated to a plurality of users using the terminal device 10 together.

Thus, the terminal device 10 according to the present embodiment may improve the convenience of information operation when the terminal device 10 is shared by a plurality of users for use.

### Second Embodiment

Next, a second embodiment is described. In the second embodiment, a case where a plurality of terminal devices 10 are used to specify an authority level set to one terminal device 10. Examples of the case include a case where, when a parent uses one terminal device 10 as a master device and a child uses another terminal device 10 as a slave device, a result of use authentication performed by the parent on the master device and a result of use authentication performed by the child on the slave device are used to set an authority level to the slave device.

In the second embodiment, differences from the first embodiment are mainly described, and descriptions of substantially the same components as in the first embodiment are omitted as appropriate.

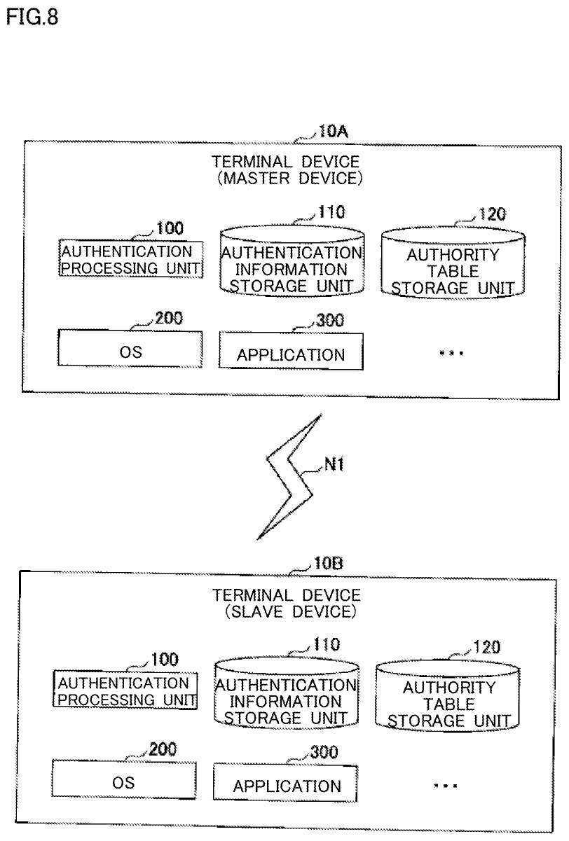

First, an overall configuration of a system including terminal devices 10 according to the present embodiment is described with reference to FIG. 8. FIG. 8 is a diagram illustrating an example of the overall configuration of the system including the terminal devices 10 according to the present embodiment.

As illustrated in FIG. 8, the system including the terminal devices 10 according to the present embodiment includes a plurality of terminal devices 10. For example, the terminal devices 10 are communicably connected through near-field communication N1 such as Bluetooth (registered trademark).

The configuration of each terminal device 10 is the same as in the first embodiment. Hereinafter, as an example, the case where the system includes a terminal device 10A as a master device and a terminal device 10B as a slave device is described.

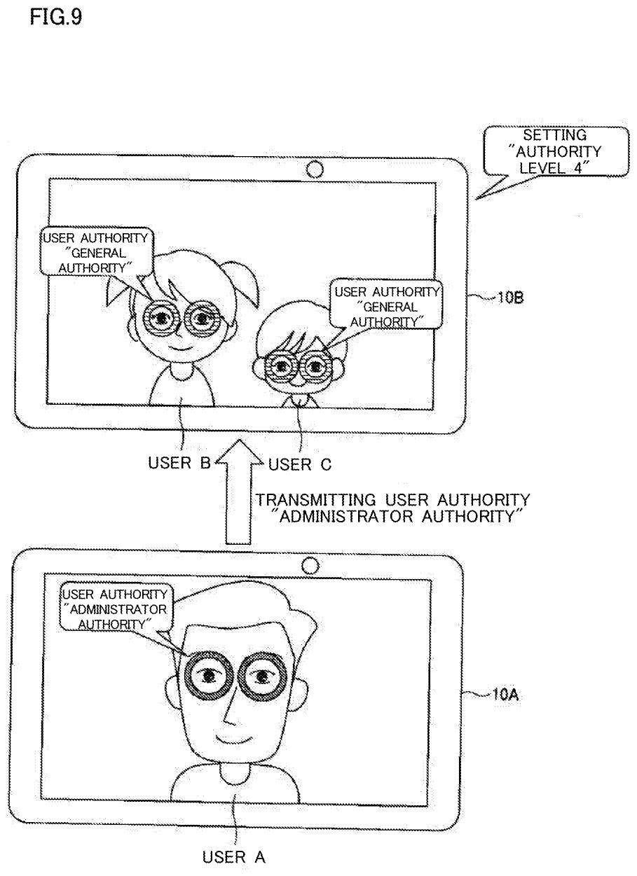

The outline in the case where the terminal device 10A and the terminal device 10B according to the present embodiment each perform use authentication to set an authority level of a user who uses the terminal device 10B is described with reference to FIG. 9. FIG. 9 is a diagram for describing an example of the setting of the authority level according to the present embodiment.

In the example illustrated in FIG. 9, a user A allocated with user authority of “administrator authority” performs use authentication by iris authentication on the terminal device 10A, and a user B and a user C allocated with user authority of “general authority” perform use authentication by iris authentication on the terminal device 10B.

When the terminal device 10A performs use authentication of the user A, the terminal device 10A transmits user authority “administrator authority” to the terminal device 10B. The terminal device 10B sets an authority level of “authority level 4” corresponding to a combination of the user authority “general authority” allocated to the user B, the user authority “general authority” allocated to the user C, and the user authority “administrator authority” received from the terminal device 10A to the OS200 or the application 300. In this manner, the user B and the user C may perform an information operation corresponding to the authority level 4 on the terminal device 10B.

As described above, the terminal device 10 according to the present embodiment sets an authority level corresponding to a combination of user authority of one or more users whose use authentication has been performed by the terminal device 10 and user authority of one or more users whose use authentication has been performed by another terminal device 10.

In this manner, for example, a parent may use his/her own terminal device 10A to change the authority level of the terminal device 10B used by a child. Thus, for example, even when the parent is on the first floor and the child is on the second floor, the parent may use his/her own terminal device 10A to change the authority level of the terminal device 10B used by the child.

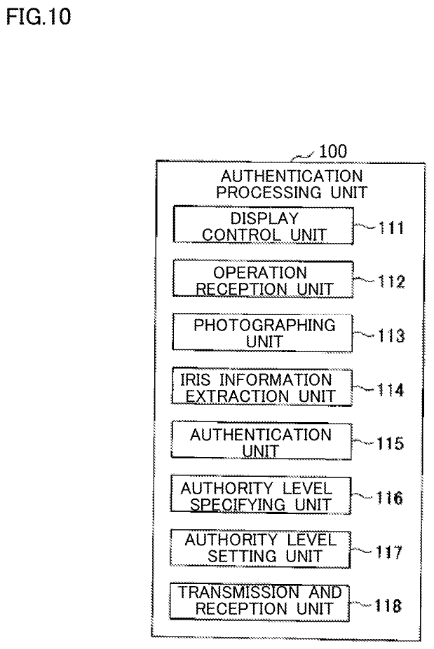

Next, a functional configuration of the authentication processing unit 100 according to the present embodiment is described with reference to FIG. 10. FIG. 10 is a diagram illustrating an example of the functional configuration of the authentication processing unit 100 according to the present embodiment.

As illustrated in FIG. 10, the authentication processing unit 100 according to the present embodiment further includes a transmission and reception unit 118. When the operation reception unit 112 receives an authentication request operation, the transmission and reception unit 118 transmits an authentication request to another terminal device 10 as a master device. The authentication request operation is an operation for requesting use authentication to another terminal device 10.

In response to an authentication request from another terminal device 10 as a slave device, the transmission and reception unit 118 replies an authentication response including the user authority specified by the authentication unit 115 to the other terminal device 10.

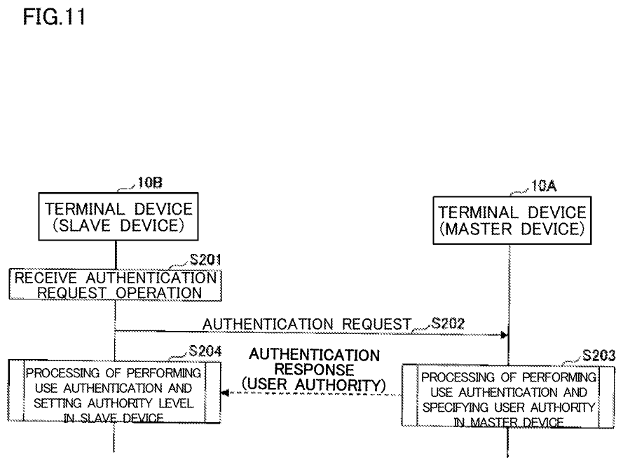

Next, the processing for performing the use authentication and setting the authority level in the system including the terminal device 10A (master device) and the terminal device 10B (slave device) according to the present embodiment is described with reference to FIG. 11. FIG. 11 is a diagram illustrating an example of the flow of overall processing for performing the use authentication and setting the authority level according to the present embodiment.

First, the operation reception unit 112 in the terminal device 10B receives an authentication request operation for requesting the terminal device 10A as a master device to perform use authentication (Step S202). For example, the user may perform the authentication request operation by pressing, on a predetermined screen displayed after the terminal device 10 is resumed from a sleep state, an icon for requesting use authentication to another terminal device 10. For example, the user performs the authentication request operation when the user wants to use the terminal device 10 at an authority level higher than that set when using the terminal device 10 by his/herself alone.

Next, when the operation reception unit 112 receives the authentication request operation, the transmission and reception unit 118 in the terminal device 10B transmits an authentication request to the terminal device 10A as a master device (Step S202).

When the transmission and reception unit 118 receives the authentication request, the terminal device 10A performs processing for performing the use authentication and the specification of user authority (Step S203). In the processing for performing the use authentication and the specification of user authority, user authority is allocated to a user of the terminal device 10A and specified, and an authentication response including the specified user authority is transmitted to the terminal device 10B. The details of the processing at this step are described later.

On the other hand, when the transmission and reception unit 118 transmits the authentication request, the terminal device 10B performs processing for performing the use authentication and setting the authority level (Step S204). In the processing for performing the use authentication and setting the authority level, an authority level corresponding to a combination of the user authority allocated to the user of the terminal device 10B and the user authority received from the terminal device 10A is set. The details of the processing at this step are described later.

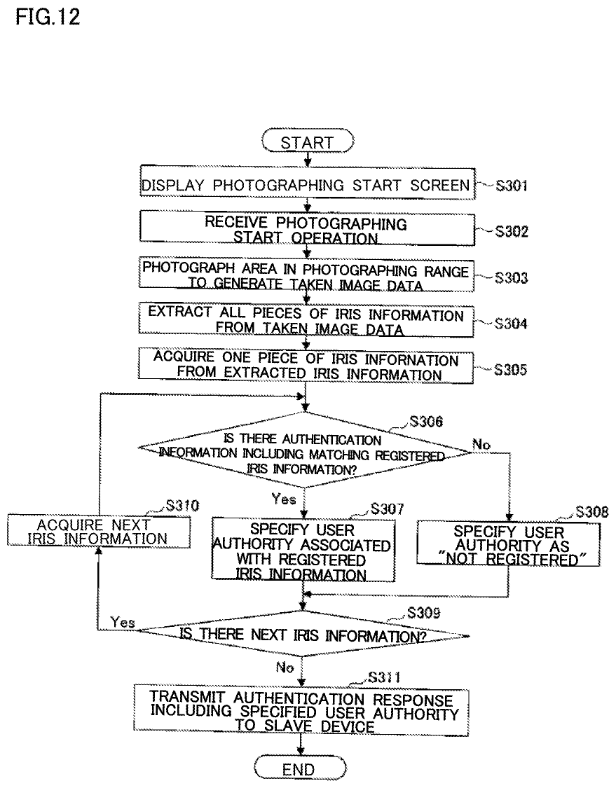

The details of the processing at Step S203 (processing for performing use authentication and specifying user authority) are described with reference to FIG. 12. FIG. 12 is a flowchart illustrating an example of the processing for performing the use authentication and specifying the user authority in a master device according to the present embodiment. Step S301 to Step S310 in FIG. 12 are the same as Step S102 to Step S111 in FIG. 7, respectively, and hence descriptions thereof are omitted.

At Step S309, when it is determined that the next iris information is not present, the transmission and reception unit 118 transmits an authentication response including the user authority specified by the authentication unit 115 to the slave device (terminal device 10B) (Step S311). In this manner, the terminal device 10A as a master device may transmit user authority of one or more users whose use authentication has been performed by the terminal device 10 to the terminal device 10B as a slave device.

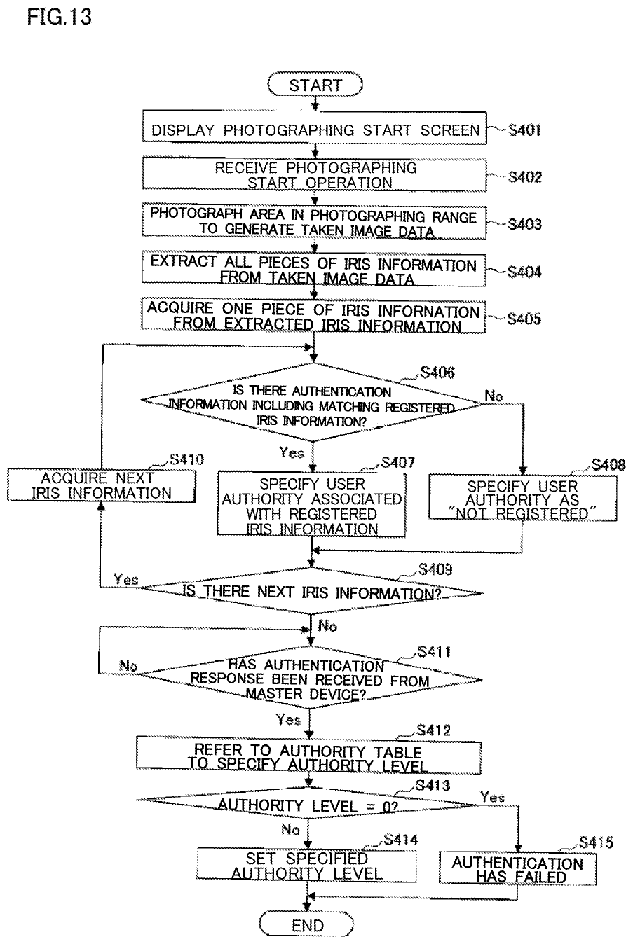

Next, the details of the processing at Step S204 (processing for performing use authentication and setting authority level) are described with reference to FIG. 13. FIG. 13 is a flowchart illustrating an example of the processing for performing the use authentication and setting the authority level in a slave device according to the present embodiment. Step S401 to Step S410 in FIG. 13 are the same as Step S102 to Step S111 in FIG. 7, respectively, and hence descriptions thereof are omitted.

At Step S409, when it is determined that the next iris information is not present, the transmission and reception unit 118 determines whether an authentication response has been received from the master device (terminal device 10A) (Step S411).

At Step S411, when it is not determined that the authentication response has been received from the master device, the authentication processing unit 100 returns to Step S411. Specifically, the authentication processing unit 100 stands by until the authentication response is received from the master device. The authentication processing unit 100 may determine that the authentication has failed when the authentication response is not received from the master device within a predetermined period.

On the other hand, at Step S411, when it is determined that the authentication response has been received from the master device, the authority level specifying unit 116 refers to the authority table 120T to specify an authority level from a combination of the user authority specified by the authentication unit 115 and the user authority included in the authentication response received by the transmission and reception unit 118 (Step S412).

Next, the authority level specifying unit 116 determines whether the authority level specified at Step S412 is “authority level 0” (Step S413).

At Step S413, when it is determined that the specified authority level is not “authority level 0”, the authority level setting unit 117 sets the specified authority level to, for example, the OS200 or the application 300 (Step S414). In this manner, a user who uses the slave device may use the slave device at the authority level set by the authority level setting unit 117.

On the other hand, at Step S413, when it is determined that the specified authority level is “authority level 0”, the authentication unit 115 determines that the authentication has failed (Step S415).

As described above, the terminal device 10 according to the present embodiment sets an authority level corresponding to a combination of user authority allocated to a user of the terminal device 10 and user authority allocated to another user who uses another terminal device 10. In this manner, for example, when a child uses the terminal device 10, a parent may use his/her own terminal device 10 to temporarily increase the authority level of the terminal device 10 used by the child.

Thus, the terminal device 10 according to the present embodiment may improve convenience of information operation on a terminal device 10 used by another user.

In the present embodiment, a terminal device 10 that transmits an authentication request is a slave device and a terminal device 10 that transmits an authentication response corresponding to the authentication request is a master device, but the master device and the slave device are distinguished for the sake of convenience, and the embodiment is not limited thereto. For example, a terminal device 10 that transmits an authentication request may be a master device and a terminal device 10 that transmits an authentication response corresponding to the authentication request may be a slave device.

In the present embodiment, the case where the number of master devices and the number of slave devices are each one has been described as an example, but the embodiment is not limited thereto. For example, a terminal device 10 as a slave device may transmit an authentication request to a plurality of terminal devices 10. In this case, the terminal device 10 as a slave device sets an authority level corresponding to a combination of user authority allocated to a user of the terminal device 10 and user authority included in authentication responses received from the respective master devices.

### Third Embodiment

Next, a third embodiment is described. In the third embodiment, the case where there is a server device 20 for specifying user authority and specifying an authority level of a user who uses a terminal device 10 is described.

In the third embodiment, differences from the second embodiment are mainly described, and descriptions of substantially the same components as in the second embodiment are omitted as appropriate.

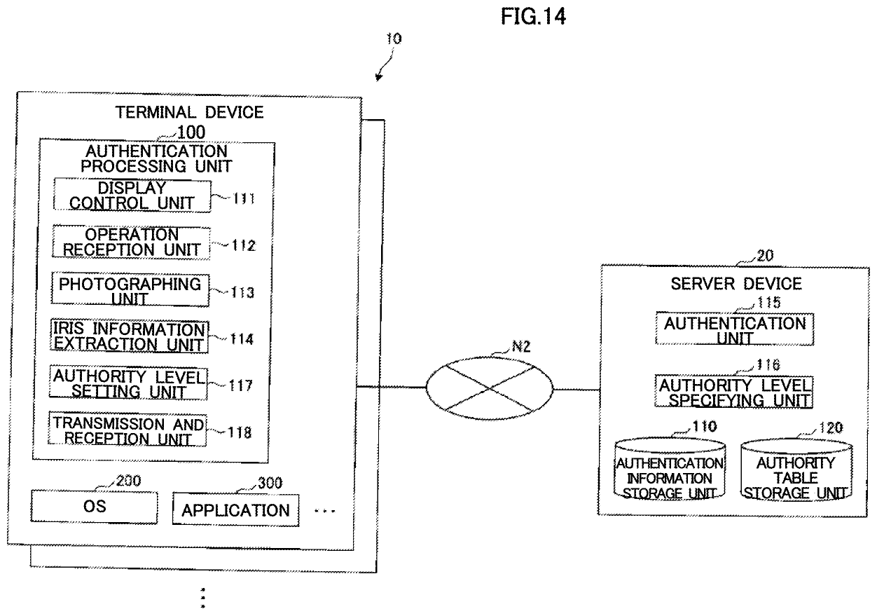

The overall configuration of a system including the terminal device 10 according to the present embodiment is described with reference to FIG. 14. FIG. 14 is a diagram illustrating an example of the overall configuration of the system including the terminal device 10 according to the present embodiment.

As illustrated in FIG. 14, the system including the terminal device 10 according to the present embodiment includes one or more terminal devices 10 and a server device 20. For example, the one or more terminal devices 10 and the server device 20 are communicably connected through a broad network N2 such as the Internet.

The terminal device 10 according to the present embodiment does not include an authentication information storage unit 110 and an authority table storage unit 120. An authentication processing unit 100 in the terminal device 10 according to the present embodiment does not include an authentication unit 115 and an authority level specifying unit 116.

On the other hand, the server device 20 according to the present embodiment includes the authentication unit 115, the authority level specifying unit 116, the authentication information storage unit 110, and the authority table storage unit 120. In this manner, server device 20 according to the present embodiment may perform the use authentication and the specification of user authority of the terminal device 10 and the specification of authority level in response to a request from each terminal device 10.

As illustrated in FIG. 14, by providing the server device 20 for performing use authentication and specification of user authority of each terminal device 10 and specification of authority levels, each terminal device 10 is not required to have the authentication information storage unit 110 and the authority table storage unit 120.

For example, even when it is not possible to communicate between the terminal device 10A as a master device and the terminal device 10B as a slave device by the near-field communication N1, the terminal device 10B may acquire user authority of the terminal device 10 from the server device 20.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device, comprising:
a first specifying unit that specifies identification information on a user who operates the information processing device and identification information on each of one or more other users who use the information processing device while sharing the information processing device with the user; and
a second specifying unit that refers to a first storage unit which has stored a range of operable information corresponding to a combination of identification information on users, to specify a range of operable information to a combination of the identification information specified by the first specifying unit.

2. The information processing device according to claim 1, comprising a receiver that receives identification information on a user who uses another information processing device,
wherein the second specifying unit specifies a range of operable information to a combination of the identification information specified by the first specifying unit and the identification information received by the receiver.

3. The information processing device according to claim 1, comprising a photographing unit that photographs the user and the one or more other users to generate taken images,
wherein the first specifying unit specifies, from the taken images, the identification information on the user and the identification information on the one or more other users.

4. The information processing device according to claim 3, wherein the identification information is iris information or information indicating a characteristic pattern of a face.

5. An information processing method, comprising executing, by a computer, processing of:
specifying identification information on a user who operates the computer and identification information on each of one or more other users who use the computer while sharing the computer with the user; and
referring to a first storage unit which has stored a range of operable information corresponding to a combination of identification information on users, to specify a range of operable information to a combination of the specified identification information.

6. The information processing method according to claim 5, comprising, by the computer, executing processing of receiving identification information on a user who uses another computer,
wherein a range of operable information is specified for a combination of the specified identification information and the received identification information.

7. The information processing method according to claim 5, comprising executing, by the computer, processing of photographing the user and the one or more other users to generate taken images,
wherein the identification information on the user and the identification information on the one or more other users are specified from the taken images.

8. The information processing method according to claim 7, wherein the identification information is iris information or information indicating a characteristic pattern of a face.

9. An information processing program for causing a computer to execute processing of:
specifying identification information on a user who operates the computer and identification information on each of one or more other users who use the computer while sharing the computer with the user; and
referring to a first storage unit which has stored a range of operable information corresponding to a combination of identification information on users, to specify a range of operable information to a combination of the specified identification information.

10. The information processing program according to claim 9, causing the computer to execute processing of receiving identification information on a user who uses another computer,
wherein a range of operable information is specified for a combination of the specified identification information and the received identification information.

11. The information processing program according to claim 9, causing the computer to execute processing of photographing the user and the one or more other users to generate taken images,
wherein the identification information on the user and the identification information on the one or more other users are specified from the taken images.

12. The information processing program according to claim 11, wherein the identification information is iris information or information indicating a characteristic pattern of a face.
